(19) United States
(12) Patent Application Publication
(10) Pub. No.: US 2014/0323934 A1
(43) Pub. Date: Oct. 30, 2014

(54) Medical Support and Compression Stocking

(71) Applicants: EMPA Eidgenossische Materialprufungs-Und Forschungsanstadt, Dubendorf (CH); Sigvaris AG, St. Gallen (CH); Unico Swiss Tex GmBH, Alpnachstad (CH); MSR Electronics GmbH, Henggart (CH)

(72) Inventors: Emilie Bertaux-Hegemann, St. Gallen (CH); Wendelin Egli, Henggart (CH); Markus Hess, Alpnachstad (CH); Frederike Lehmeier, St. Gallen (CH); Lino Missagia, St. Gallen (CH); Markus Weder, St. Gallen (CH)

(73) Assignees: EMPA Eidgenossische Materialprufungs-Und Forschungsanstadt, Dubendorf (CH); Sigvaris AG, St. Gallen (CH); Unico Swiss Tex GmbH, Alpnachstad (CH); MSR Electronics GmbH, Henggart (CH)

(21) Appl. No.: 14/359,179

(22) PCT Filed: Nov. 20, 2012
(86) PCT No.: PCT/EP2012/073133

§ 371 Date: May 19, 2014

(30) Foreign Application Priority Data
Nov. 21, 2011 (CH) 01862/11

(51) Int. Cl. A61H 1/00

(52) U.S. Cl. CPC A61H 1/008
USPC 601/148

(57) ABSTRACT

In order to improve the use of a medical support and compression stocking, it is proposed that the stocking (10) shall comprise a woven- or knitted-fabric-type base element (20) that is substantially tubular and that can be pulled over the lower leg of the wearer. Moreover, the stocking comprises at least one air chamber (30) that can be filled with air. The air chamber (30) is designed in a tubular shape along the length of the support and compression stocking. The stocking further comprises an electronic unit that is equipped with a micropump and a valve for the air supply, the micropump being provided with a valve, a current source, preferably a rechargeable battery and control electronics including a wireless data transfer unit. The pressure values of the at least one air chamber can be regulated by means of the data transfer unit and a software stored in the electronic unit.

### FIELD OF THE INVENTION

The invention relates to a medical support and compression stocking.

### BACKGROUND OF THE INVENTION

Support and compression stockings and similar aids have been known for a long time—inter alia from EP 2 138 140 A2, DE 10 2008 029 289 A1, DE 10 2006 048 313 A1 , DE 199 44 030 C1.

Medical compression stockings are nowadays used particularly by elderly people suffering from venous disease. In order to prevent subsequent diseases like, for example, thrombosis, such stockings should be worn as often as possible. However, a major problem of simple elastic support and compression stockings is putting them on and removing them. Due to the relatively high compression, which is in the range of 15 to more than 49 mm Hg, the elastic stocking needs to be strongly stretched when being put on, thus requiring a strong effort on the part of the wearer of the support and compression stocking. For this reason, it is sometimes necessary to have externally assisted handling, e.g. via medical care enterprises or professional medical staff, for putting on and removing the stocking.

The well-known simple elastic support and compression stockings are usually very limited in their application, which means that the compression can be adjusted manually at the very most.

From US 2009/234262 A1 there is known a monitoring system for recording the physical condition, e.g. also at the leg, by means of sensors of some kind. In this context there are also mentioned inflatable bladders which of course are already known in principle—for generating a pressure in the system. However, no measures on how to facilitate application of the inflatable bladders can be drawn from US 2009/234262 A1. The monitoring system from US 2009/234262 A1 is not intended or suitable for extended wearing, as it is seems primarily suited for an inpatient treatment of lymphatic diseases.

In US 2011/082 401 A1 there is disclosed a device for applying pressure in various sectors, including the treatment of lymphatic problems. Thereby, the pressure is applied by means of multiple air chambers. The chambers are inflated sequentially and then simultaneously deflated in order to achieve a massaging movement for drainage of fluid accumulated in the tissue. The device of US 2011/082 401 A1 is configured as a sleeve that is wrapped over the leg. This produces a high thermal insulation, and also for this reason the device—just like the monitoring system of US 2009/234262 A1—is not intended or suitable for extended wearing, but rather for short-term outpatient treatment,

### DESCRIPTION OF THE INVENTION

Therefore, the object of the invention is to propose an improved medical support and compression stocking by means of which the above described disadvantages of the prior art can be at least avoided. Therefore, the compression stocking should be easy to put on and remove and be more flexible in its applications than simple elastic support and compression stockings according to the prior art. Moreover, the stocking should be suitable for an extended period of wearing.

This object is achieved by means of an improved medical support and compression stocking according to claim 1. Hereby, the measures of the invention have initially the result that the medical compression stocking is a custom-tailored stocking that is adjusted to the leg of the wearer and—assuming that it fits—can be put on like a normal sock relatively easily and without particular effort. After having put on the stocking, the zippers or another tensioning device—if available—can be closed so that the stocking already fits relatively well on the lower leg and cannot slide down any longer. Thereby the pre-compression on the leg is preferably about 5 to maximally 10 mm Hg upon closing the zippers. Thereafter, the actual compression is applied—even if a variant without a tensioning device is chosen—by filling the air chamber or the air chambers of the medical compression stocking with air. According to the present invention, the chambers have a substantially tubular shape. This has the following advantage: A flat tube becomes rounded upon filling and the diameter thereof is reduced to such an extent that the tube becomes completely round. There are various possibilities to configure the walls of the air chamber. According to the present invention, the walls of the air chambers comprise airtight membranes that are designed in such manner that they have at least a defined breathability to allow the body moisture to diffuse, wherein the water vapor transfer resistance Ret shall not exceed 20 m² Pa/W,

The stocking is preferably equipped with an electronic unit that is provided with a micropump with a valve for the air supply, a preferably rechargeable battery and control electronics including a unit for wireless data transfer, for example onto a “smart phone”, preferably through an application (App) by means of which the stocking can be operated. The operation comprises regulating the pressure values, selecting an appropriate pressure profile, readout of the data and further actions.

It is advantageous if the tube is not completely round, but rather kidney-shaped, which results in a better application of the force. Moreover, the pressure onto the leg is spread over a larger area in the region of the air tube, The advantage of this type of applying compression is that a substantially continuously rising pressure of 5 to 50 mm Hg can be applied onto the leg, and that the pressure can be varied in time almost arbitrarily so as to provide the wearer with a therapy that is as individual and customized as possible.

Advantageously, the electronic unit comprises at least one pressure sensor that continuously measures the pressure in the at least one air chamber and activates the electronics according to a momentary target pressure in order to keep the pressure value constant or matching a predetermined or currently calculated value.

It is particularly advantageous if the electronic unit comprises at least an acceleration sensor, with said software being set up in such manner that a motion-induced pressure adjustment is provided, whereby a lower compression pressure is preferably set at rest, especially in a sitting or lying position of the wearer, as compared to a moving situation, so that upon movements of the wearer the pressure can be increased to a previously defined higher pressure value.

The medical support and compression stocking can be configured as lower leg bandage or—advantageously—it can be provided with footlets. Moreover, the stocking can comprise corresponding extensions for the upper leg with corresponding further air chambers. The stocking can even be part of a pair of trousers.

It should be noted at this point that “airtight” in the sense of the present invention means that the pressure loss is smaller than the ability to refill the air through the pump. Typically, the airtightness of the chambers is so good that the pressure in the chamber does not substantially decrease and remains almost constant over a time period of one hour.

The aforementioned elements as well as those claimed and described in the following exemplary embodiments, to be used according to the invention, are not subject to any particular conditions by way of exclusion in terms of their size, shape, use of material and technical design, with the result that the selection criteria known in the respective field of application can be used without restrictions. In particular, the application is not limited to the medical field in strict terms, but can also pertain to the fields of space medicine, sports medicine etc. for the persons concerned therewith. Moreover, the application is also possible for the prevention of flight thrombosis or in the domain of wellness.

In particular, it should be mentioned that specific advantages of the present invention could also be achieved without electronic units, namely with a medical support and compression stocking comprising a woven- or knitted-fabric-type base element that is substantially tubular, which is designed in such manner that it can be pulled over the lower leg of the wearer, at least one air chamber that can be filled with air, wherein the at least one air chamber is designed in a tubular shape along the length of the support and compression stocking if the woven- or knitted-fabric-type base element comprises at least one tensioning device, preferably at least one zipper or at least one Velcro fastener, and wherein the walls of the at least one air chamber are designed in such manner that they comprise at least a defined breathability to allow the body moisture to diffuse, wherein the water vapor transfer resistance Ret shall not exceed 20 m² Pa/W. The tensioning device can then be designed in such manner that the support and compression stocking in the closed state of the tensioning device fits on the lower leg in such manner that the support and compression stocking cannot slip down whereas in the open state of the tensioning device the support and compression stocking can be easily put on to the lower leg and easily removed from the lower leg. Advantageously, also in this case at least one tubular air chamber is designed in such manner that the air chamber becomes rounded upon filling and the diameter thereof is reduced or becomes a kidney-shaped upon filling. The inflation may be achieved by means of a hand pump, and a mechanical pressure monitoring may be provided. In the case of non-medical applications it is sufficient if the wearer adjusts the pressure by means of a manual hand pump in such manner as to feel a pleasant compression pressure at the leg.

### BRIEF DESCRIPTION OF THE DRAWINGS

Examples of the invention will henceforth be described in more detail by reference to the drawings, which show:

FIG. 1 a schematic view of the elements of a medical support and compression stocking according to a to a first exemplary embodiment of the invention in its layered structure, in the basic state;

FIG. 2 a schematic view of the elements of the medical support and compression stocking in its layered structure according to FIG. 1, in the inflated state;

FIG. 3 a schematic view of the elements of the medical support and compression stocking as a plan view according to FIG. 1, in the basic state;

FIG. 4 a schematic view of the elements of a medical support and compression stocking according to a first exemplary embodiment of the invention in its layered structure, in the basic state;

FIG. 5 a schematic view of the elements of a medical support and compression stocking according to an alternative exemplary embodiment of the invention with a simple, attached finger pump; and

FIG. 6 a schematic view of the elements of a medical support and compression stocking according to a further alternative exemplary embodiment of the invention with an external hand pump.

### MODES FOR CARRYING OUT THE INVENTION

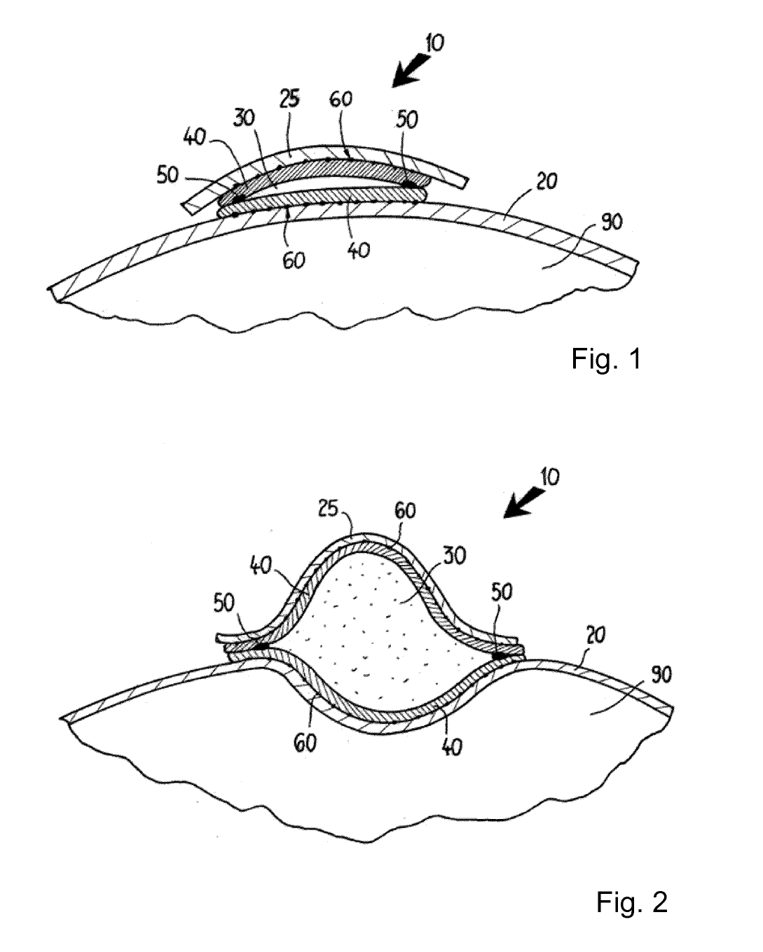

The medical support and compression stocking 10 according to a first exemplary embodiment of the present invention shown in its layered structure in FIG. 1 comprises a first, substantially non-stretchable woven- or knitted-fabric-type base layer 20 which is in contact with the skin of the leg 90 of the wearer. The woven- or knitted-fabric-type base layer 20 forms the actual stocking. This layer is configured as a stocking and has, in the exemplary embodiment, a circumference that allows for an easy application, that is, a circumference that is slightly greater than the thickness of the wearer's leg. Once the wearer has put on the stocking, he can bring the stocking to a snug fitting by closing a tensioning zipper (not shown), whereby, however, the properties of a support or compression stocking in a strict sense (with a pressure of 5 to 50 mm Hg according to the above mentioned compression conditions) are not yet established. In the exemplary embodiment the woven- or knitted-fabric-type base layer 20 is made of PA6.6 (just as an example). However, to increase wearing comfort, it is of course contemplated to also have layers made of known natural materials.

On top of the woven- or knitted-fabric-type base layer 20 there is provided an air chamber 30 that is formed by means of two airtight membrane layers 40. In the exemplary embodiment, the lower membrane layer 40 is laminated onto the woven- or knitted-fabric-type base layer 20 by means of a lamination 60. The two airtight membrane layers 40 are connected to each other in an airtight manner at their outer edges by means of a laser welding seam 50 so that an airtight air chamber 30 can be formed.

On top of the air chamber 30 that is formed by means of the two airtight membrane layers 40, namely on top of the outer membrane layer, there is applied a woven- or knitted-fabric-type cover layer 25, which in the present exemplary embodiment is also laminated by means of a lamination 60. FIG. 2 shows the structure according to FIG. 1 in the inflated state of the air chamber 30. In this state an air pressure—which is 50 mm Hg in the exemplary embodiment—is maintained in the air chamber 30 by virtue of the feature that the membranes 40 are airtightly formed and also airtightly connected to each other by means of laser welding. Due to this effect the two edges of the membranes 40, i.e. the partial portions or ends which in these regions are connected with the membranes 40 by means of lamination are drawn together and cause a compression that acts accordingly on the leg of the wearer and thus provide the desired support property.

The support and compression stocking comprises a pressure control device for 5 to 50 mm Hg circumferential tensile stress related to the filling pressure of the air chambers. The preliminary tension of the stocking is generated by means of zippers that can be closed after putting on. A pressure sensor incorporated in the electronic unit 70 continuously measures the pressure applied to the leg 90 and actuates the electronics accordingly so as to keep the target pressure value as constant as possible or matching a predetermined or currently calculated value. The medical support and compression stocking comprises two air chambers (air tubes) in the exemplary embodiment. The membranes 40 that are used for the air chambers 30 have absolute airtightness.

On the other hand the membranes are breathable up to a certain extent to allow the body moisture to diffuse. The water vapor transfer resistance Ret shall not exceed 20 m² Pa/W. In the exemplary embodiment described here this is a polyetherester membrane made of Sympatex having a thickness of about 15-30 μm. Alternatively, a polyurethane membrane made of Epurex or an equivalent material is contemplated.

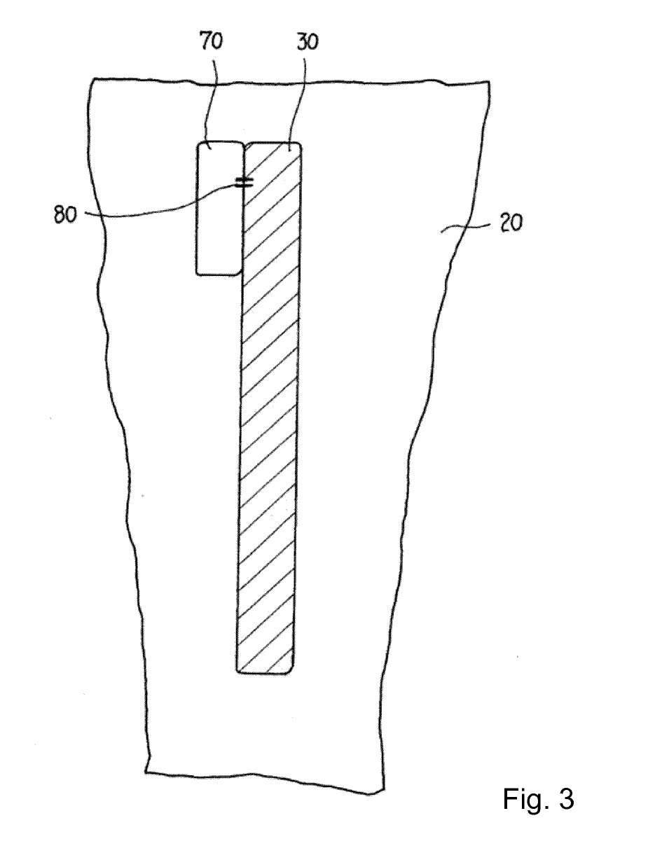

FIG. 3 shows a schematic plan view on the layered structure according to FIG. 1 with the woven- or knitted-fabric-type base layer 20 forming a base and with the air chamber 30 configured as air tube forming a support. The cover layer 25 is not shown in FIG. 3. An electronic unit 70 with data logger, pump, battery and motion sensor—in the present exemplary embodiment comprising 3D acceleration sensors—and a radio module—in the present exemplary embodiment a WiFi radio module—is arranged laterally on the air chamber 30, and the air chamber 30 is cooperatively connected with the pressure pump of the electronic unit by means of a valve 80 in such manner that pressure can be built up and also released.

The inflating of the air chamber or air chambers is made possible by means of an electric micropump. An electronics with pump, battery, 3D acceleration sensors and software for controlling the various programs are incorporated in the stocking. The unit is programmed in such manner that a motion-induced pressure adjustment is provided, whereby a relatively low compression pressure is preferably set at rest (in a sitting or lying position), whereas upon walking the pressure is automatically increased to a previously defined higher pressure value.

By means of the incorporated motion sensor it can be determined what the person is currently doing and, accordingly, a previously defined compression pressure value can be set individually al a new target value.

The entire compression stocking can also be used as a pressure sensor. For this purpose, a defined pressure is set at rest, and by observing any changes of this pressure upon physical movement the muscle contraction in the lower leg can be registered and the quality of the vascular system can be assessed from the shape of the pressure curve.

For non-medical applications such as e.g. the prevention of flight thromboses, the domain of wellness, or the shortening of the recovery period in the field of sports, the stocking can also be used without electronics. The stocking is then inflated by means of either an incorporated simple hand pump or an external pump until the desired pressure at the leg is achieved. Depending on the situation, one can slightly refill or release some pressure by opening a mechanical valve after a certain time.

The stocking can also be equipped with footlets or even be an entire pair of trousers, by means of which also the upper leg can be compressed.

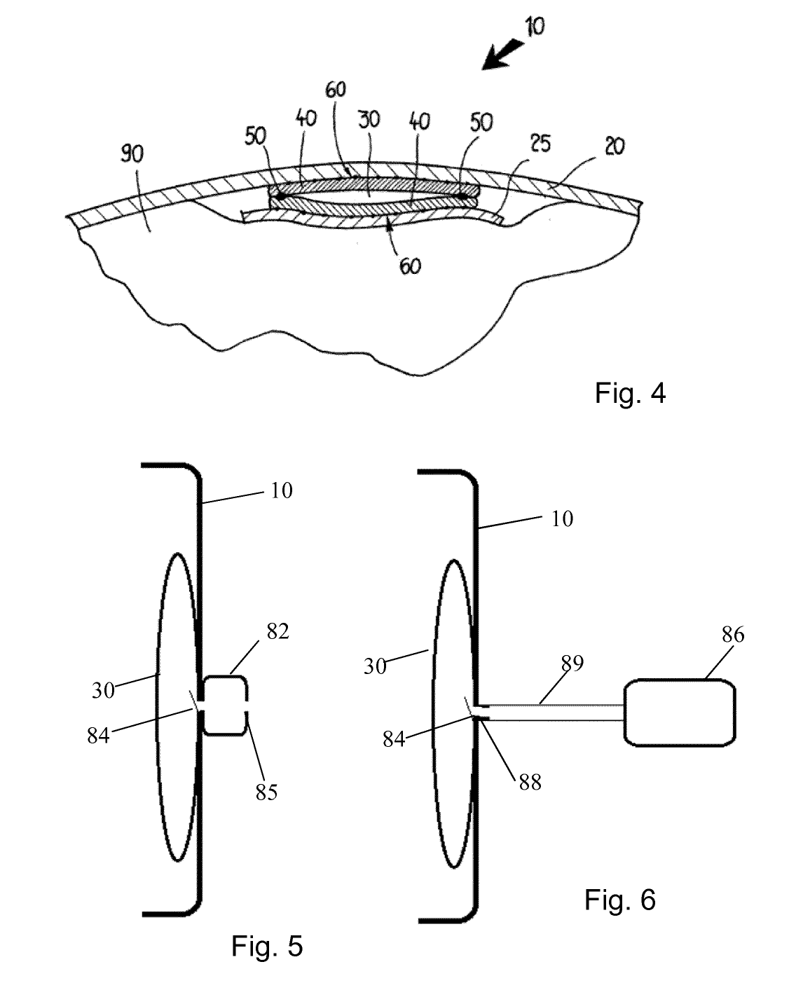

In an alternative embodiment according to FIG. 4 the layered structure has been modified in such manner that the air chamber 30 formed by the membranes 40 is now provided between the leg 90 of the wearer and the woven- or knitted-fabric-type base layer 20 that forms the actual stocking. In this case, the cover layer 25 covers the membranes 40 against the leg 90. Apart from this, a similar structure is used as in the exemplary embodiment according to FIG. 1.

In a further alternative embodiment according to FIG. 5 there is provided an attached finger pump 82. Thereby, the air chamber 30 is closed off from the finger pump 82 by means of a valve—in the present exemplary embodiment a valve flap 84—and will be only opened upon compression of the pump while the finger block 85 of the finger pump is closed by the applied finger pressure.

In another alternative embodiment according to FIG. 6 there is provided a detachable conventional pump 86 that is also shown in the figure as a hand pump. Also in this case the air chamber 30 is closed off, now with respect to the outer surroundings 82, by means of a valve—in the present exemplary embodiment a valve flap 84—and and will only be opened by virtue of the fact that the filling port 86 is provided with an overpressure with respect to the air chamber 30. In this case, a connection hose 89 of the hand pump 86 is connected with the filling port. Of course, the “hand pump” 86 can again be configured as a mechanically or electrically operating pump.

### LIST OF REFERENCE NUMERALS

10 Medical support and compression stocking
20 woven- or knitted-fabric-type base layer
25 woven- or knitted-fabric-type cover layer
30 air chamber
40 airtight membrane
50 laser welding seam
60 lamination of the woven- or knitted-fabric-type base layer with the airtight membrane
70 electronic unit with data logger, pump, battery and radio module
80 valve to the pump with pressure sensor
82 attached finger pump
84 valve for hand or finger pump
85 finger block for the attached hand pump
86 external hand pump
88 filling port
89 detachable air connection hose
90 leg of the wearer

1. A medical support and compression stocking, comprising
a woven- or knitted-fabric-type base element that is substantially tubular, which is designed in such manner that it can be pulled over the lower leg of the wearer, at least one air chamber that can be filled with air, wherein the at least one air chamber is designed in a tubular shape along the length of the support and compression stocking,
characterized in that the woven- or knitted-fabric-type base element comprises at least one tensioning device, preferably at least one zipper or at least one Velcro fastener, and wherein the walls of the at least one air chamber are designed in such manner that they comprise at least a defined breathability to allow the body moisture to diffuse, where the water vapor transfer resistance Ret shall not exceed 20 m²Pa/W.

2. The medical support and compression stocking according to claim 1, characterized by an electronic unit that is equipped with a micropump for the air supply, the micropump being provided with a valve, and by a power source, preferably a rechargeable battery, wherein the electronic unit comprises control electronics including a preferably wireless data transfer unit, wherein the pressure values of the at least one air chamber can be regulated by means of the data transfer unit and a software stored in the electronic unit.

3. The medical support and compression stocking according to claim 2, characterized in that the electronic unit comprises at least one pressure sensor that continuously measures the pressure in the at least one air chamber and activates the electronics according to a current target pressure in order to keep the pressure value constant or on a predetermined value or currently calculated value.

4. The medical support and compression stocking according to claim 1, characterized in that the electronic unit comprises at least an acceleration sensor, wherein said software is set up in such manner that a motion-induced pressure adjustment is provided, wherein a lower compression pressure is set preferably at rest, especially in the sitting or lying position of the wearer than while moving, wherein upon moving of the wearer the pressure can be increased to a previously defined higher pressure value.

5. The medical support and compression stocking according to claim 1, characterized in that the tensioning device is designed in such manner that the support and compression stocking in the closed state of the tensioning device fits on the lower leg in such manner that the support and compression stocking cannot slip down, whereas in the open state of the tensioning device the support and compression stocking can be easily put on to the lower leg and easily removed from the lower leg.

6. The medical support and compression stocking according to claim 1, characterized by an attached or detachable hand or finger pump.

7. The medical support and compression stocking according to claim 1, characterized in that at least one tubular air chamber is designed in such manner that the air chamber becomes rounded upon filling and the diameter thereof is reduced.

8. The medical support and compression stocking according to claim 1, characterized in that the at least one tubular air chamber is designed in such manner that it assumes a kidney-shaped form upon filling.

9. The medical support and compression stocking according to claim 1, characterized in that the walls of the at least one air chamber comprise airtight membranes.

10. The medical support and compression stocking according to claim 1, characterized in that the stocking is equipped with footlets.

11. The medical support and compression stocking according to claim 1, characterized in that the stocking comprises corresponding extensions for the upper leg with corresponding further air chambers.

12. The medical support and compression stocking according to claim 11, characterized in that the stocking is part of a pair of trousers.

13. The medical support and compression stocking according to claim 2, characterized in that the electronic unit comprises at least an acceleration sensor, wherein said software is set up in such manner that a motion-induced pressure adjustment is provided, wherein a lower compression pressure is set preferably at rest, especially in the sitting or lying position of the wearer than while moving, wherein upon moving of the wearer the pressure can be increased to a previously defined higher pressure value.

14. The medical support and compression stocking according to claim 3, characterized in that the electronic unit comprises at least an acceleration sensor, wherein said software is set up in such manner that a motion-induced pressure adjustment is provided, wherein a lower compression pressure is set preferably at rest, especially in the sitting or lying position of the wearer than while moving, wherein upon moving of the wearer the pressure can be increased to a previously defined higher pressure value.

15. The medical support and compression stocking according to claim 2, characterized by an attached or detachable hand or finger pump.

16. The medical support and compression stocking according to claim 3, characterized by an attached or detachable hand or finger pump.

17. The medical support and compression stocking according to claim 4, characterized by an attached or detachable hand or finger pump.

18. The medical support and compression stocking according to claim 5, characterized by an attached or detachable hand or finger pump.

19. The medical support and compression stocking according to claim 2 characterized in that the walls of the at least one air chamber comprise airtight membranes.

20. The medical support and compression stocking according to claim 3 characterized in that the walls of the at least one air chamber comprise airtight membranes.
